(19) United States
(12) Patent Application Publication
(10) Pub. No.: US 2012/0276253 A1
(43) Pub. Date: Nov. 1, 2012

(54) Cocktail Shaker-Shaped Foil Pouch With Straw

(76) Inventors: Ryan Paul Considine, Darien, CT (US); Maria Considine, Darien, CT (US)

(21) Appl. No.: 13/457,365

(22) Filed: Apr. 26, 2012

Related U.S. Application Data
(60) Provisional application No. 61/479,808, filed on Apr. 27, 2011.

(51) Int. Cl. B65D 85/72; B65D 77/38; C12G 3/00; B65D 77/28

(52) U.S. Cl. 426/85; 426/106; 426/122

(57) ABSTRACT

A metallic foil pouch whose body has a contour of convex and concave curvatures and lacks right-angled edges. The body has one side transparent or translucent and an opposite side of metallic foil. The contents of the body include an alcoholic beverage. A straw is secured to the body, which has a portion that is penetrable by manual force for insertion of the straw.

### CROSS-REFERENCE TO COPENDING PATENT APPLICATIONS

The present application asserts the benefit of priority from provisional patent application Ser. No. 61/479,808 filed Apr. 27, 2011.

### BACKGROUND OF THE INVENTION

1. Field of the Invention

The present invention is in the field of foil pouches containing alcoholic beverages.

2. Discussion of Related Art

Automated foil pouch packaging systems are known. For instance, Sealed Air Corp. describes its system in 2005:
The Cryovac Onpack 2100A vertical form-fill-seal system enables food manufacturers to package faster and for less cost in a pouch, says Sealed Air, the manufacturer. The bag-in-box system is suitable for packaging liquid and semi-liquid foods and can package product containing food particulates up to 1.5 in. in diameter. The system automates the filling process, packaging the product in pouches instead of pails and can fill up to 20 pouches in one minute in sizes ranging from 1.5 to 5 gallons.

In March 2003, an article was published in FoodEngineering entitled “Pouches challenge manufacturers to think outside the box” that predicted that many flexible pouches would be taking on boxy shapes. This prediction continues come true for pouches containing alcoholic beverages up until the filing of the inventor's provisional patent application on Apr. 27, 2011. The following are a sampling of such pouches.

BOISSET FAMILY ESTATES offers wines in a collapsible container for sale through their website www.frenchrabbit.com. Their container is boxy and elongated with straight edges. Their website describes their Tetra Prisma container as follows:
Tetra-Prisma containers are state-of-the-art packaging that will revolutionize the wine industry. 100% recyclable, Tetra-Prisma containers reduce packaging by 90% in comparison to typical glass wine bottles. In fact, Tetra-Prisma containers have less packaging than an egg! These light weight containers weigh only 3% of the total weight, while an eggshell weighs 7% of the total weight of an egg. With an easy-to-use twist off cap, collapsable design and 2 extra glasses per container, Tetra Prisma containers make French rabbit wines the most convenient wine available. Click on the circles below to learn more about French rabbit's amazing packaging design.

In March 2011, the Cell Drinks pouch was launched whose silhouette includes straight, concavely curved and convexly curved edges. The use of soft pouch packaging has expanded to alcoholic drinks, with UK company Cell Drinks launching a new brand of ‘dancefloor-friendly’ pouched non-spill vodka drinks.

Further in 2011, a website belonging to ShotPaQ LLC (http://www.shotpakinc.com/) offered for sale pouches containing alcoholic beverages. The silhouette of the pouch includes straight edges and rounded corners.

In 2012, GOOD TIME BEVERAGES introduced a pouch containing a cocktail that has concave and convex curvature along its sides. They have a website at www/goodtimebeverages.com that provides in part:
However, we were not satisfied with the current packaging options available after all the hard work to develop the perfect cocktail. Glass bottles are too heavy and too common, cans had their day, plastic bottles are not environmentally friendly, and paper boxes just fill up landfills, and are too heavy to ship and have no shelf pizzazz. Plus we wanted the lightest most earth friendly package for our products.
Thus we spent another year looking for the perfect package. We looked to the leading consumer package goods companies, who over the past few years have moved to lighter, more flexible and greener packaging. We decided to jump on the pouch trend and created a flexible consumer friendly and environmentally considerate pouch to hold our premium margarita and other cocktails.
Our flex pouch offer space savings, they are light weight and lead the charts on all accounts as the perfect recyclable landfill friendly green package (see our “Green Packaging” section).
Copyright© 2012 Good Time Beverages.

Polymer Packaging Inc. promotes its flexible packaging product line on its website at www.polymerpkg.com/flexible/shaped-pouches/. The silhouette of its packaging includes concave and convex curvature.
Shaped-beverage pouches are the latest creative packaging solution for the food and beverage industry. Polymer Packaging, Inc. is leading the development of shaped-beverage pouch solutions for everything from alcoholic cocktails to fruit drinks, and our customers are reaping the benefits.

The conventional foil pouches all are opaque, even for those pouches that contain alcoholic beverages. However, the present inventor is aware that cocktails are not prone to the same kind of spoilage from exposure to solar radiation as are other kinds of food and beverage products. Therefore, it would be desirable to make the pouch in a manner that allows would be purchasers to see the contents of the pouch before purchase or even during use so as to know when the pouch is empty. It is further desirable to provide a metallic foil pouch whose shape is other than boxy, i.e., has no right angled edges, and contains alcoholic beverages so as to better resemble conventional cocktail containers that have inclined surfaces, concave surfaces, convex surfaces but lack right angled edges.

### SUMMARY OF THE INVENTION

One aspect of the invention resides in a foil pouch product that has a body having one side transparent or translucent and an opposite side being metallic foil and whose contents include alcohol. Preferably, the body lacks right-angled edges, i.e., has a contour with inclined surfaces and convex and concave curvatures.

Another aspect resides in a substantially straight straw within a plastic seal and releasably secured to the body, the body having side configurations that a symmetric with each other, each of the side configurations including a bottom portion, a middle portion and a top portion, the bottom portion angling from a bottom outwardly, the middle portion angling inwardly with curvature from the bottom portion to the top portion, the top portion having a juncture with the middle portion whose width is substantially the same as a width at the bottom of the bottom portion, the bottom portion defining a distance from the bottom to the middle portion that is greater than an entire length of the straw. Preferably, the straw is within plastic seal, and there are loops or sleeve openings extending from the body and into which is retained the straw within the plastic seal to the body.

A further aspect resides in providing a printed layer on the body that includes as an image of a clock whose hour hand points in a manner designating five o'clock.

### BRIEF DESCRIPTION OF THE DRAWING

For a better understanding of the present invention, reference is made to the following description and accompanying drawings, while the scope of the invention is set forth in the appended claims.

FIG. 1 is an isometric view of a metallic foil pouch product in accordance with the invention;

FIG. 2 is a front view thereof;

FIG. 3 is a left side view thereof;

FIG. 4 is a right side view thereof;

FIG. 5 is a rear view thereof;

FIG. 6 is a top view thereof; and

FIG. 7 is a bottom view thereof.

### DESCRIPTION OF THE PREFERRED EMBODIMENT

The metallic foil pouch of the invention is reminiscent of conventional juice metallic foil pouches and thus the manufacturing process for the metallic foil pouches is the same, except as indicated in the following.

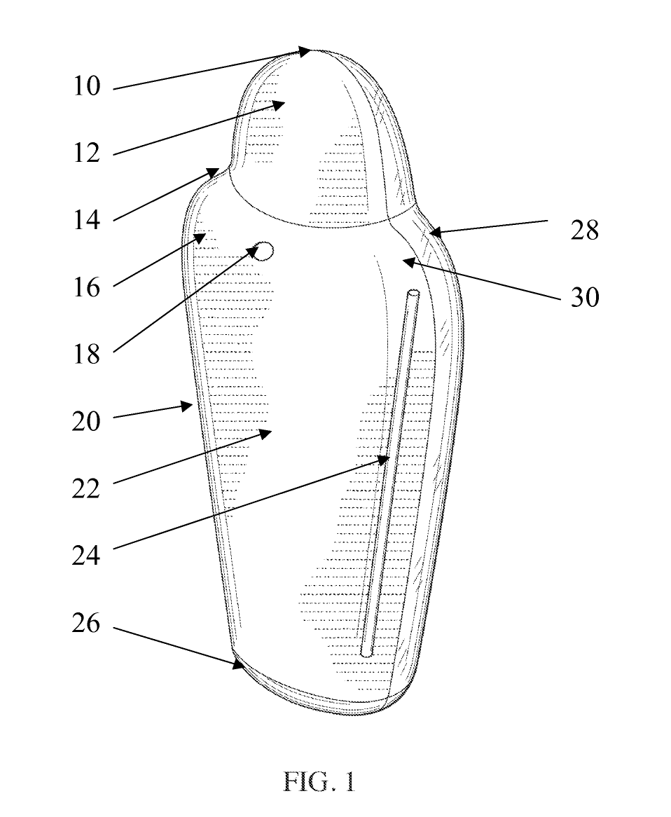

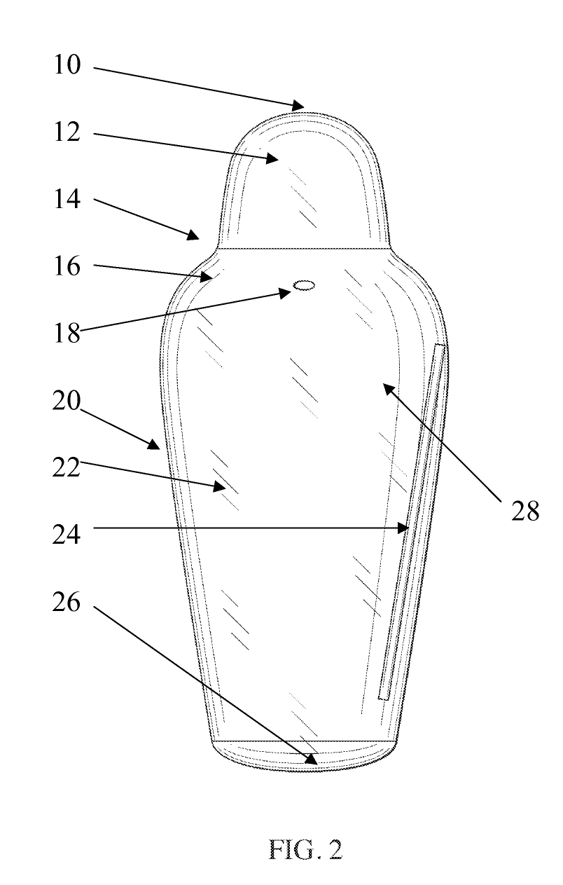

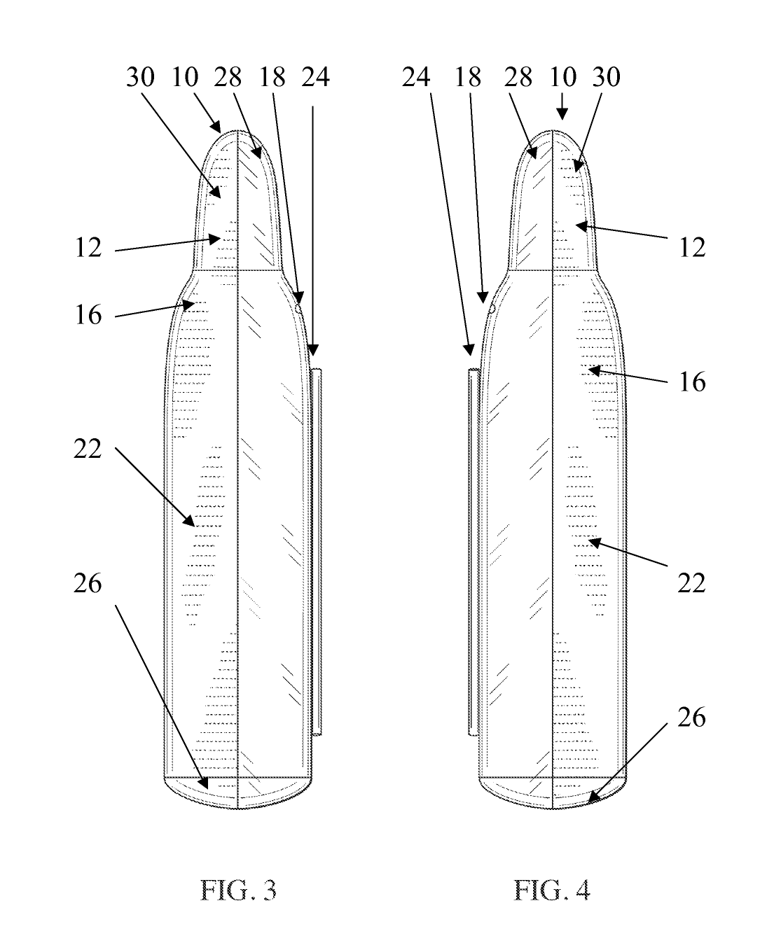

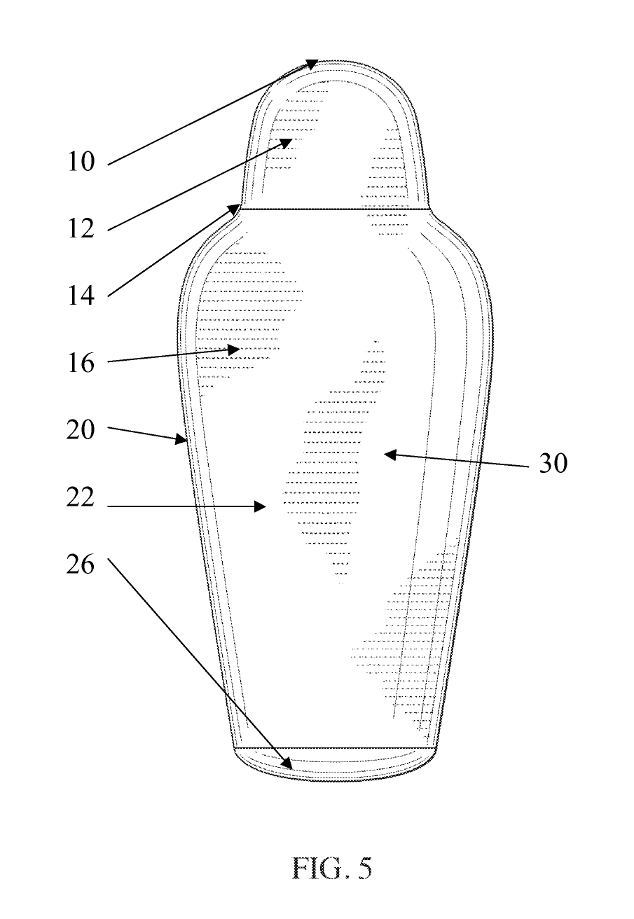

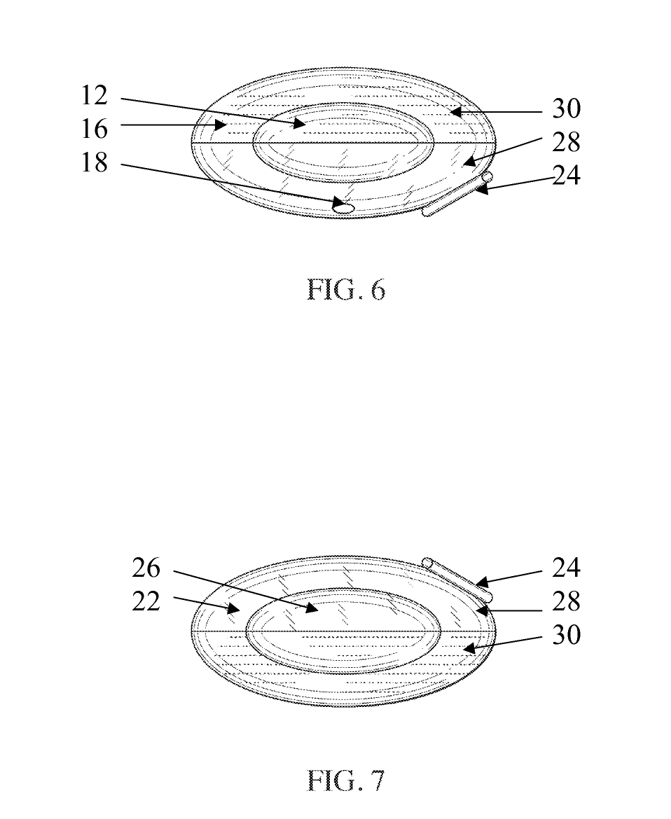

Turning to FIGS. 1-7, instead of being rectangular shaped front and back, the invention is reminiscent of the contour of a conventional cocktail shaker as to the shape of its sides. The silhouette of the elongated sealed body is defined by a contour that is symmetric on both sides in the figures. The contour includes curvatures and inclined edges. The curvatures may be either convex or concave. The inclined edges are either diverging or converging, depending upon the direction with respect to the elongation of the body.

The body itself may be considered to be the composite of a bottom portion 22, a middle portion 16 and a top portion 12. The middle portion 16 is between the top portion 12 and the bottom portion 22. The bottom portion 22 is the longest lengthwise. The bottom portion terminates at a base 26 while the top portion terminates at a top end 10 opposite the base 26.

The bottom portion has an incline edge 20 that defines part of the contour. The incline edge 20 converges to the base 26. On the other hand, the incline edge 20 diverges to the middle portion 16. The middle portion 16 has a curvature 14, which is convex in the figures. The smallest width defined across the body between the convex curvatures 14 of either side of the middle portion 16 is substantially the same dimension as a width of the base 26.

The top portion's edge that forms part of the contour are either substantially parallel or converge more gradually than the middle portion 16 until either rounding off at the top end 10 in a convexly curved manner as shown or being flat at the top (not shown).

While the entire bottom and front of the foil body are formed of a shiny, metallic foil 30 that is opaque as is known conventionally for conventional metal foil pouches, the entire rear of the foil pouch is preferably made of a transparent or translucent material 28 to allow visual inspection from the outside of the contents, which is the alcoholic beverage. The rear may be made of a durable plastic material welded to the shiny, metallic foil of the bottom and rear.

The welding may be in any conventional manner, such as by sonic welding or thermal welding. The exact location of the welding depends upon the extent of transparency or translucency desired for the foil pouch. For instance, the entire rear is transparent, but, if desired, portions of the top, bottom and sides that are adjacent the rear may likewise be transparent. A welded seam between the metallic foil and the transparent plastic portions could extend along the middle of the sides and midway along the top and bottom, which may be helpful for the manufacturing process. This is because the foil pouch would be evenly split area-wise between a metallic foil portion and a transparent plastic portion and thus be readily aligned with each other (when placed one over the other) for conducting the thermal or sonic welding process to form seams without the need for making additional folds beforehand to do so.

Otherwise, the top and/or bottom could instead be entirely shiny metallic or entirely transparent if desired instead of evenly split between the two materials. An exemplary manufacturing process would lay an entire sheet of transparent plastic over an entire sheet of shiny metallic and then the welding would occur to form the seams, except along the top. This way, multiple cocktail shaker-shaped foil pouches may be thereby formed adjacent or spaced from each other in the two sheets. The two sheets, which now have a series of thermally welded or sonically welded seams, would then be cut along their peripheries, i.e., immediately adjacent to the outside of the seams. Beverage could then be filled through the unseamed top and thereafter the top welded closed at its seam with the sides, front and rear.

A straw 24 is secured to the outside of the body of the foil pouch of the present invention in a conventional manner to allow its easy removal by the user by pulling it off after breaking a plastic seal containing the straw, except that the straw is preferably angled in alignment with and adjacent one of the gradual diverging edges 20 that diverge from the bottom. The length of the gradual diverging edge 20 needs to be at least as long as the straw, but preferably at least a little longer to allow ends of the plastic seal to be readily secured to it.

As an alternative to the conventional manner of securing a plastic seal for a substantially straight straw to a foil pouch, sleeves or bands may be provided in accordance with the invention to retain the plastic seal containing the straw to the foil pouch. In the case of sleeves, there would be either one at the top or bottom or two of them: one at the top and the other at the bottom of the gradual upward sides each preferably extending across the front. The sleeves may have openings into which is friction fitted the plastic seal containing the straw. As an alternative, one or both of the sleeves may instead to bands that preferably extend at least the front of the foil pouch with to form loops into which may be fitted the plastic seal with the straw.

The contents of the foil pouch of the invention is an alcoholic beverage. The alcoholic beverage does not degrade in quality or integrity when exposed to sunlight for extended periods, which is why the front of the foil pouch in accordance with the invention may be transparent or translucent and why such is not done for convention juice foil pouches. The alcoholic beverage is preferably a cocktail, which is any of various mixed alcoholic drinks consisting usually of brandy, whiskey, vodka or gin combined with fruit juices or other liquors.

As is done conventionally in the case of juice packs, a small opening 18 is provided on the body towards the top of the pouch that is sealed by a metallic foil that may be punctured by insertion of a straw, such as one whose end is cut to incline thereby forming a cutting edge. For instance, such a small opening 18 may be in the middle portion of the foil pouch. In effect, the metallic foil at the small opening that seals the small opening is in effect a yielding portion in that it yields to the end of the straw being manually forced against it so as to allow for penetration of the straw by becoming punctured.

If desired, perforations may be provided in the top portion at a location spaced from the middle portion to circle around the periphery of the top portion to allow the uppermost part of the top portion to be ripped off the remainder of the body where the perforations reside. The top portion of the foil pouch may remain empty or substantially empty of the alcoholic contents, which instead fill up just the bottom and middle portions (and perhaps some of the top beneath the level of the perforations). This arrangement allows one to pour the contents of the foil pouch out through the top opening formed by removing the perforated top rather than needing to penetrate the straw through the small opening (in the middle portion) to suction out the contents.

The foil pouch may have a printed layer on the body that includes an image of a clock whose hour hand (and perhaps a minute hand) that points in a manner designating five o'clock. Since many businesses close at 5 PM sharp, such an image may serve as a reminder to such workers as to the appropriate time for safely consuming the contents of the foil pouch of the invention Monday through Friday during the traditional work week, i.e., they need to wait at least until conclusion of the traditional work day that ends at 5 PM. This is because many businesses have policies to discipline employees who either show up to work inebriated from consuming alcohol prior to commencement of the work day or who consume alcohol at work during the work day.

The contour of the body of the foil pouch has convex and concave curvatures. Preferably, there are no right-angled edges. While conventional foil pouches may round corners of their bodies, they still all have right-angled edges even through the corner between the edges is rounded. In contrast, the edges in accordance with the invention incline to define the convex and/or concave curvatures.

While the foregoing description and drawings represent the preferred embodiments of the present invention, it will be understood that various changes and modifications may be made without departing from the scope of the present invention.

What is claimed is:

1. A foil pouch product, comprising an elongated sealed body having one face that is made of a transparent or translucent material and an opposite face that is made of a metallic foil material, the body containing an alcoholic beverage.

2. The foil pouch product of claim 1, wherein the body has a silhouette defined by a contour, the contour having a portion with a curvature, the curvature being selected from a group consisting of concave curvature and convex curvature.

3. The foil pouch product of claim 2, wherein the contour includes a further portion that inclines between the curvature and a base of the body in a substantially straight incline.

4. The foil pouch product of claim 3, wherein the contour extends along opposite sides of the body, each of the sides having the curvature so that with respect to a direction of elongation of the body, widths across the body between curvature of each side of the body vary, at least one of the widths being substantially identical in dimension to a width of the base across the body.

5. The foil pouch product of claim 1, wherein the body has a plurality of portions that include a bottom portion, a middle portion and a top portion, the middle portion being between the top portion and the bottom portion, the body having a silhouette defined by a contour along a respective edge of each of the plurality of portions, each of the respective edges defining a shape selected from the group consisting of concave curvature, convex curvature, incline convergence, and incline divergence, the top portion having a width that is smaller in dimension than a width of the middle portion, the bottom portion converging to a base whose width is smaller in dimension than the width of the middle portion.

6. The foil pouch product of claim 5, wherein the bottom portion angles from the middle portion to a base provide the incline convergence, the middle portion angles inwardly toward the top portion to provide the convex curvature.

7. The foil pouch product of claim 5, further comprising a substantially straight elongated straw extending along the body in a direction substantially parallel to an inclination of the bottom portion that converges to the base, the bottom portion defining a distance from the base to the middle portion that is greater in length than an entirety of a length of the substantially straight straw, the body having a yielding portion that yields under manual pressure to enable penetration by manually forcing an end of the straw through the yielding portion.

8. The foil pouch product of claim 1, wherein the alcoholic beverage contained within the body is a cocktail, which is a mixed alcoholic drink.

9. The foil pouch product of claim 1, wherein the body lacks right-angled edges.

10. The foil pouch product of claim 1, wherein the top portion has perforations that may rip under manual force.

11. A foil pouch product, comprising an elongated sealed body that includes metallic foil material and that has a silhouette defined by a contour, the contour having a curved portion with a curvature and a further portion that inclines between the curved portion and a base of the body in a converging manner toward the base in a substantially straight incline, the curvature being selected from a group consisting of concave curvature and convex curvature, the body containing an alcoholic beverage.

12. The foil pouch product of claim 11, wherein the contour extends along opposite sides of the body, each of the sides having the curvature so that with respect to a direction of elongation of the body, widths across the body between curvature of each side of the body vary, at least one of the widths being substantially identical in dimension to a width of the base across the body.

13. The foil pouch product of claim 11, wherein the body has a plurality of portions that include a bottom portion, a middle portion and a top portion, the middle portion being between the top portion and the bottom portion, the body having a silhouette defined by a contour along a respective edge of each of the plurality of portions, each of the respective edges defining a shape selected from the group consisting of concave curvature, convex curvature, incline convergence, and incline divergence, the top portion having a width that is smaller in dimension than a width of the middle portion, the bottom portion converging to a base whose width is smaller in dimension than the width of the middle portion.

14. The foil pouch product of claim 13, wherein the bottom portion angles from the middle portion to a base provide the incline convergence, the middle portion angles inwardly toward the top portion to provide the convex curvature.

15. The foil pouch product of claim 13, further comprising a substantially straight elongated straw extending along the body in a direction substantially parallel to a direction of inclination of the bottom portion that converges to the base, the bottom portion defining a distance from the base to the middle portion that is greater in length than an entirety of a length of the substantially straight straw, the body having a yielding portion that yields under manual pressure to enable penetration by manually forcing an end of the straw through the yielding portion.

16. The foil pouch product of claim 11, wherein the alcoholic beverage contained within the body is a cocktail, which is a mixed alcoholic drink.

17. The foil pouch product of claim 11, wherein the body lacks right-angled edges.

18. The foil pouch product of claim 13, wherein the top portion has perforations that may rip under manual force.
